(19) United States
(12) Patent Application Publication
(10) Pub. No.: US 2017/0374037 A1
(43) Pub. Date: Dec. 28, 2017

(54) SECURE DATA TRANSMISSION VIA EMAIL

(71) Applicant: Secured2 Corporation, Minneapolis, MN (US)

(72) Inventors: R. Daren KLUM, Shoreview, MN (US); Mark Hansen, Eden Prairie, MN (US)

(21) Appl. No.: 15/631,792

(22) Filed: Jun. 23, 2017

Related U.S. Application Data
(60) Provisional application No. 62/354,295, filed on Jun. 24, 2016.

(51) Int. Cl. H04L 29/06

(52) U.S. Cl. CPC H04L 63/0428; H04L 63/0838; H04L 63/04; H04L 63/08

(57) ABSTRACT

Methods and systems for secure transmission of data in an email are provided. In one embodiment, a secure email transmission system is provided that includes a sender email GUI and a recipient email GUI. The sender email GUI generates a sender composed email and sends a secured email to the recipient email GUI. The recipient email GUI retrieves the secured email and presents the sender composed email to a recipient.

### FIELD

Embodiments of this disclosure relate generally to data security. More specifically, the embodiments relate to a method and system for secure transmission of data in an email.

Growing use of internet ready devices, social media and e-commerce has led to increased interconnectivity of the world around us. This increased interconnectivity can create security concerns for users of the internet. Digital communication via email is a standard form of communication over the internet that is increasingly at risk for exploitation by third parties. Ensuring security of emails sent between parties is becoming increasingly necessary as the internet evolves.

### SUMMARY

Methods and systems for secure transmission of data via email are described.

In particular, the methods and systems described herein allow a sender to send an email securely through multiple layers of security in an efficient manner to prevent a third party from retrieving the contents of the email.

In one embodiment, a method for generating and sending a secure email to a recipient is provided. The method includes receiving, via a sender email graphical user interface (GUI), a secure email instruction to secure the sender composed email. The method also includes converting the sender composed email into a secured email. Also, the method includes the sender email GUI sending the secured email to a recipient.

In another embodiment, a method for accessing a sender composed email via a secured email is provided. The method includes a recipient email GUI receiving notification of a secured email. The method also includes receiving a recipient instruction to access contents of the sender composed email. Also, the method includes a secured email component generating a verification code and sending the verification code to the recipient. Further, the method includes directing the recipient to provide verification for access to the sender composed email. The method further includes verifying that the recipient has access to the sender composed email. Moreover, the method includes retrieving the sender composed email upon receiving verification from the verification page.

In yet another embodiment, a secure email transmission system is provided. The system includes a sender email GUI and a recipient email GUI. The sender email GUI generates a sender composed email and sends a secured email to the recipient email GUI. The recipient email GUI retrieves the secured email and presents the sender composed email to a recipient.

### DRAWINGS

FIG. 1 schematically depicts a secure email transmission system according to one embodiment.

FIG. 2 is a flow chart for generating and sending a secured email to a recipient, according to one embodiment.

FIG. 3 is a screenshot of an email window of a sender composed email via a sender email GUI, according to one embodiment.

FIG. 4 is a screenshot of an email window of a sender composed email with a secure email menu via a sender email GUI, according to one embodiment.

FIG. 5 is a screenshot of an email window of a secured email via a sender email GUI, according to one embodiment.

FIGS. 6A and 6B are flow charts for accessing a sender composed email via a secured email, according to one embodiment.

FIG. 7 is a screenshot of an email window of an email list via a recipient email GUI, according to one embodiment.

FIG. 8 is a screenshot of an email window of a secured email via a recipient email GUI, according to one embodiment.

FIG. 9 is a screenshot of an email window of a verification email via a recipient email GUI, according to one embodiment.

FIG. 10 is a screenshot of a secured email access window of a secured email via a secured email GUI, according to one embodiment.

FIG. 11 is a screenshot of an email window of a sender composed email via a secured email GUI, according to one embodiment.

FIG. 12 schematically depicts an architecture of a computing device and computing system optionally used in connection with computer-implemented systems and methods described in this document.

### DETAILED DESCRIPTION

The following description describes methods and systems for secure transmission of data in an email.

The methods and systems described herein allow a sender to send an email securely through multiple layers of security in an efficient manner to prevent a third party from retrieving the contents of the email.

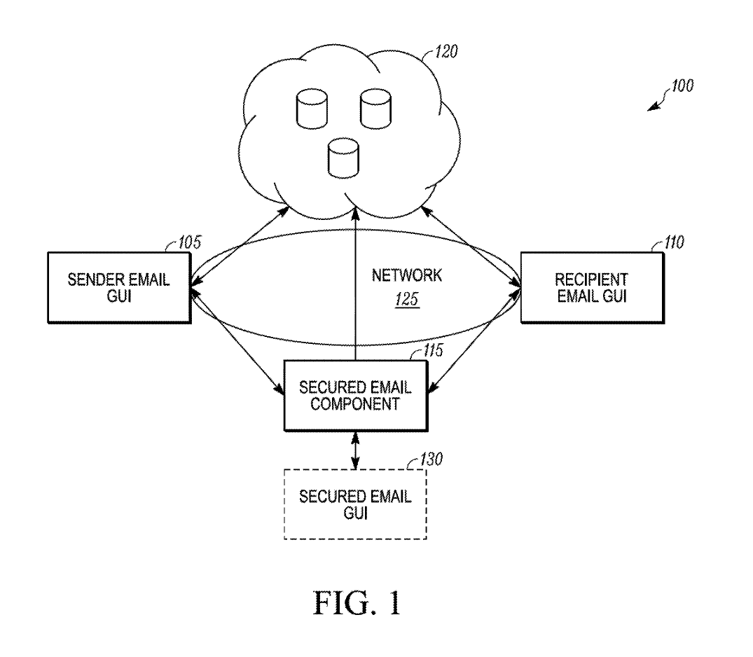

With reference to FIG. 1, one example of a secure email transmission system 100 that is capable of allowing a sender to generate and send a secure email and of allowing a recipient to access a sender composed email via a secured email is provided.

The secure email transmission system 100 includes a sender email GUI 105, a recipient email GUI 110, a secured email component 115, and a plurality of data storage locations 120 all connected via data network(s) 125.

The sender email GUI 105 and the recipient email GUI 110 can be any type of email interface that allows a user to send and receive email communications. The sender and recipient email GUIs 105, 110 can be provided locally on a computer device(s) (e.g., Microsoft Outlook), can be provided on the Internet (e.g., Gmail), or a combination of both. The sender email GUI 105 and the recipient email GUI 110 can share the same GUI platform (e.g., the sender email GUI 105 and the recipient email GUI 110 being Microsoft Outlook) or can have different GUI platforms (e.g., the sender email GUI 105 being Microsoft Outlook and the recipient email GUI 110 being Gmail).

The secured email component 115 is configured to work with the sender email GUI 105 to convert a sender composed email into a secured email and to work with the recipient email GUI 110 to access and convert a secured email into a sender composed email. In some embodiments, the secured email component 115 can be a component of the sender email GUI 105 and/or the recipient email GUI 110. In some embodiments, the secured email component 115 can be one or more servers that are separate from the computer device(s) hosting the sender email GUI 105 and/or the recipient email GUI 110. In some embodiments, the secured email component 115 can be a combination of two or more of a component of the sender email GUI 105, a component of the recipient email GUI 110, and a separate server(s). When the secured email component 115 includes a server(s), the secure email transmission system 100 can optionally include a secured email GUI 130 associated with a server(s) of the secured email component 115.

The data storage locations 120 can be public locations, private locations, or a combination of public locations and private locations for storing data. Public locations can include cloud data storage locations available on the Internet examples of which include, but are not limited to, Rackspace, Amazon, Microsoft, Google, EMC and the like. Private locations can include servers or other data storage devices connected via a local area network, such as a company network, to the secured email component 115 and optionally to the sender email GUI 105, the recipient email GUI 110, and/or the optional secured email GUI 130. The data storage locations 120, whether public or private, can be any location that has a CPU, memory, and a hard drive making the location suitable for receiving, storing and transmitting a plurality of data segments.

The network(s) 125 can be a public network like the Internet or other wide area network, a local area network, a private network, etc. or any combination thereof. As shown in FIG. 1, the secured email component 115 is connected to the data storage locations 120, the sender email GUI 105 and the recipient email GUI 110 via the network(s) 125. In some embodiments, the secured email component 115 can also be connected to the optional secured email GUI 130 via the network(s) 125. Optionally, the sender email GUI 105, the recipient email GUI 110, the secured email component 115, the data storage locations 120 and the optional secured email GUI 130 can be connected to each other via different networks of the network(s) 125.

The optional secured email GUI 130 can be an email interface that allows a user access a secured email. The optional secured email GUI 130 can be provided locally on a computer device, can be provided on the Internet, or a combination of both.

Methods for generating and sending a secure email and for allowing a recipient to access a sender composed email via a secured email using a secure email transmission system such as the secure email transmission system 100 are discussed below.

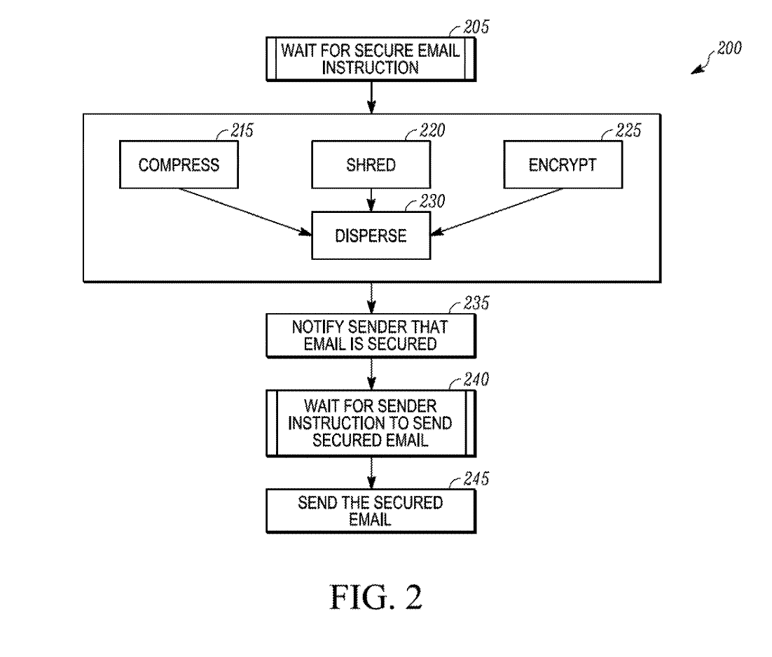

FIG. 2 is a flow chart of a method 200 for generating and sending a secure email to a recipient, according to one embodiment.

The method 200 begins at 205 where a sender email GUI waits to receive a sender instruction to secure a sender composed email (including any attachments provided therein) prior to transmission of the email to a recipient. In some embodiments, this can include the sender, in an email window of the sender composed email, selecting a secure email option from a ribbon portion of the email window. Once the sender email GUI receives the sender instruction to secure a sender composed email (including any attachments provided therein), the method 200 proceeds to 210.

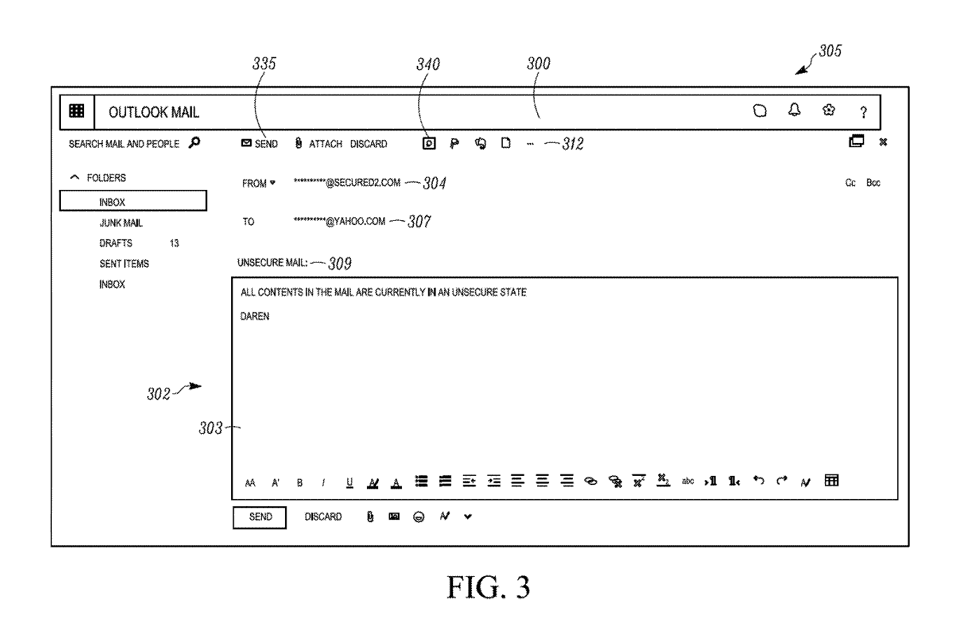

As shown in FIG. 3, an email window 300 of a sender composed email 302 is presented via a sender email GUI 305. The sender composed email 302 includes an email body portion 303, a sender portion 304, a recipient portion 307, a subject portion 309, and a ribbon portion 312. The email body portion 303 allows a sender to provide information to be sent to a recipient. The sender portion 304 allows a sender to identify a particular email account(s) sending the sender composed email 302. The recipient portion 307 allows a sender to identify recipient(s) to receive the sender composed email 302. The subject portion 309 allows a sender to provide a subject line for the sender composed email 302. The ribbon portion 312 includes a send option 335 that allows a sender to send the sender composed email 302 and a secure email menu option 340 that allows a sender to secure the sender composed email 302 prior to a secured email being sent to the recipient(s).

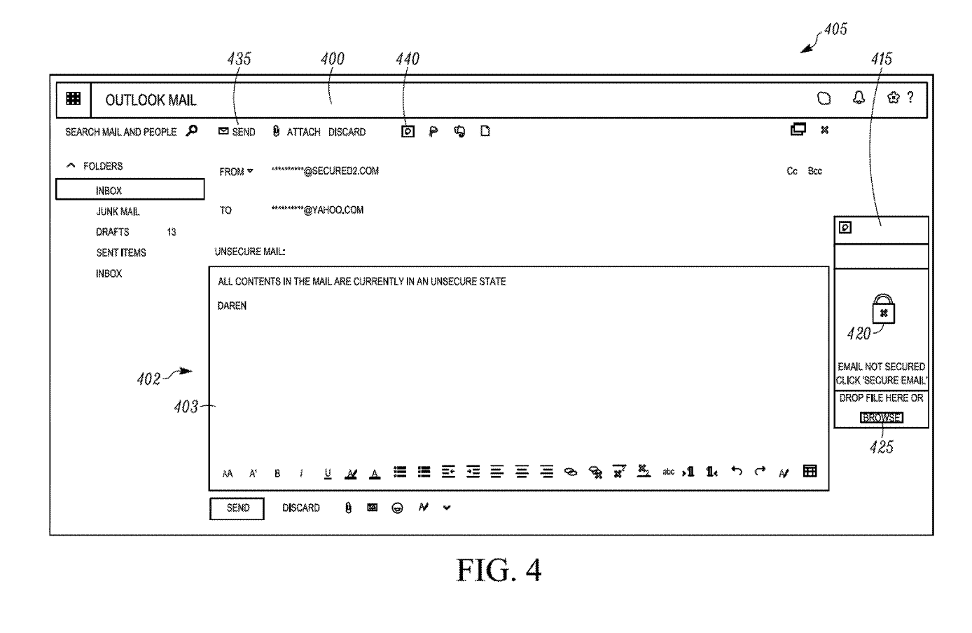

FIG. 4 illustrates a screenshot of an email window 400 of a sender composed email 402, presented via a sender email GUI 405, after a sender selects the secure email menu option 350 shown in FIG. 3. The email window 400 includes a secure email menu 415 that includes a secure email option 420 and an attach file option 425. At 205, the sender email GUI can wait for the sender to select the select the secure email option 420 before the method 200 proceeds to 210. Prior to the secure email option 425 being selected, the email window 400 includes an email body portion 403 that allows a sender to provide information to be sent to a recipient. The attach file option 425 allows a sender to include and secure any attachments to the sender composed email. In the embodiment shown in FIG. 4, the sender can select the attach file option 425 in order to browse and select the file(s) to be attached to the email, and/or the sender can drag and drop the file(s) to be attached at the location of the attach file option 425.

At 210, the sender composed email (including any attachments provided therein) is converted into a secured email. Converting the sender composed email into a secured email includes compressing the sender composed email at 215, shredding the sender composed email at 225, encrypting the sender composed email at 225, dispersing the sender composed email at 230, and notifying the sender that the sender composed email has been converted to a secured email. In some embodiments, the sender composed email can be converted into the secured email via the sender email GUI. In other embodiments, the sender composed email can be converted into the secured email via a secured email component connected to the sender email GUI. In yet some other embodiments, the sender email GUI and the secured email component can work in tandem to convert the sender composed email into the secured email.

Compressing the sender composed email at 215 includes compressing one or more files that make up the sender composed email (including any attachments provided therein). The files that make up the sender composed email can be compressed using, for example, any suitable decompression technique and/or industry standard decompression process. In some embodiments, the one or more files can be compressed by 90% or more. In some embodiments, the sender email GUI can compress the sender composed email. In other embodiments, the secured email component can compress the sender composed email. In yet some other embodiments, the sender email GUI and the secured email component can both compress the sender composed email.

Shredding the sender composed email at 220 includes dividing the one or more files that make up the sender composed email (including any attachments provided therein) into a plurality of data segments. Splitting the data into segments can be accomplished, but is not limited to, in the following exemplary manner. Shredding the sender composed email into a plurality of data segments can be based on a configuration selected by the sender as well as factoring in transmission time for the plurality of data segments. The shredding process can be configured such that each data segment has a maximum size of “N” MB. In one example, the default maximun size of each data segment can be 7 MB. Then based on the total size of the one or more files that make up the email after compression (215) and/or encryption (225), the one or more files is divided into a maximum of 1000 segments and the size of the plurality data segments is adjusted between ˜1 MB and a maximum “N” MB. If the maximum number of data segments is reached, the process can create greater than 1000 data segments with each data segment being “N” MB in size. In some embodiments, the sender email GUI can shred the sender composed email. In other embodiments, the secured email component can shred the sender composed email.

Encrypting the sender composed email at 225 includes encrypting the one or more files that make up the sender composed email (including any attachments provided therein). The encryption process can be any suitable decryption technique and/or industry standard decryption process, including for example, 128 bit or 256 encryption. In some embodiments, encrypting the sender composed email at 225 can be performed on the one or more files that make up the sender composed email prior to shredding the sender composed email (220). In other embodiments, encrypting the sender composed email at 225 can be performed on the plurality of data segments generated after shredding the sender composed email (220). In yet some other embodiments, encrypting the sender composed email at 225 can be performed on the one or more files that make up the sender composed email prior to shredding the sender composed email (220) and can be performed on the plurality of data segments generated after shredding the sender composed email (220). In these embodiments, encrypting the one or more files that make up the sender composed email prior to shredding the sender composed email (220) and encrypting the plurality of data segments generated after shredding the sender composed email (220) can use the same encryption technique or can use different encryption techniques.

In some embodiments, the sender email GUI can encrypt the sender composed email. In other embodiments, the secured email component can encrypt the sender composed email. In yet some other embodiments, the sender email GUI and the secured email component can both encrypt the sender composed email.

Once the one or more files that make up the sender composed email (including any attachments provided therein) are compressed (215), shredded (220) and encrypted (225) (in no particular order), the resulting plurality of data segments are then dispersed at 230. Dispersing the plurality of data segments can include assigning each of the plurality of data segments to a data storage location from two or more data storage locations and sending each of the plurality of data segments to two or more data storage locations. In some embodiments, the sender email GUI can disperse the plurality of data segments to the two or more data storage locations. In other embodiments, the secured email component can disperse the plurality of data segments to the two or more data storage locations.

In some embodiments, the plurality of data segments can be randomly assigned to a particular data storage location. Also, in some embodiments, the data storage locations can be randomly selected from a sender generated list of possible data storage locations. In this embodiment, the sender is able to designate which data storage locations can be used, with the sender selections being stored in a list of available data storage locations. The plurality of data segments are then randomly assigned and sent to some or all of the data storage locations on the list. The plurality data segments are each tagged in a manner to allow later retrieval and reassembly of the plurality of data segments into the original sender composed email.

In addition, a report can be generated and suitably stored, for example, in one of the data storage locations that indicates information suitable for retrieval and reassembly of the plurality of data segments. For example, the report can contain a key(s) for decrypting the plurality of data segments and the one or more files that make up the sender composed email (including any attachments provided therein), a file name assigned to each data segment, a file name assigned to each of the one or more files that make up the sender composed email, a destination data storage location of each data segment, and a sequence required to reassemble the plurality of data segments into the one or more files that make up the sender composed email. The report, or at least the data in the report, can be encrypted as well.

The data storage locations can be public data storage locations, private data storage locations, or a combination of public data storage locations and private data storage locations. Public data storage locations can include cloud data storage locations available on the Internet (including, but not limited to, Rackspace, Amazon, Microsoft, Google, EMC and the like). Private data storage locations can include servers or other data storage devices connected via a local area network to the user device that is sending the sender composed email, such as company networks. In one embodiment, the private data storage locations can be owned by or at least subject to the control of the owner of the user device. The data storage locations, whether public or private, can be any locations each of which has a CPU, memory, and a hard drive making the locations suitable for receiving, storing and transmitting the plurality of data segments.

Once the plurality of data segments are dispersed to two or more data storage locations, the method 200 proceeds to 235.

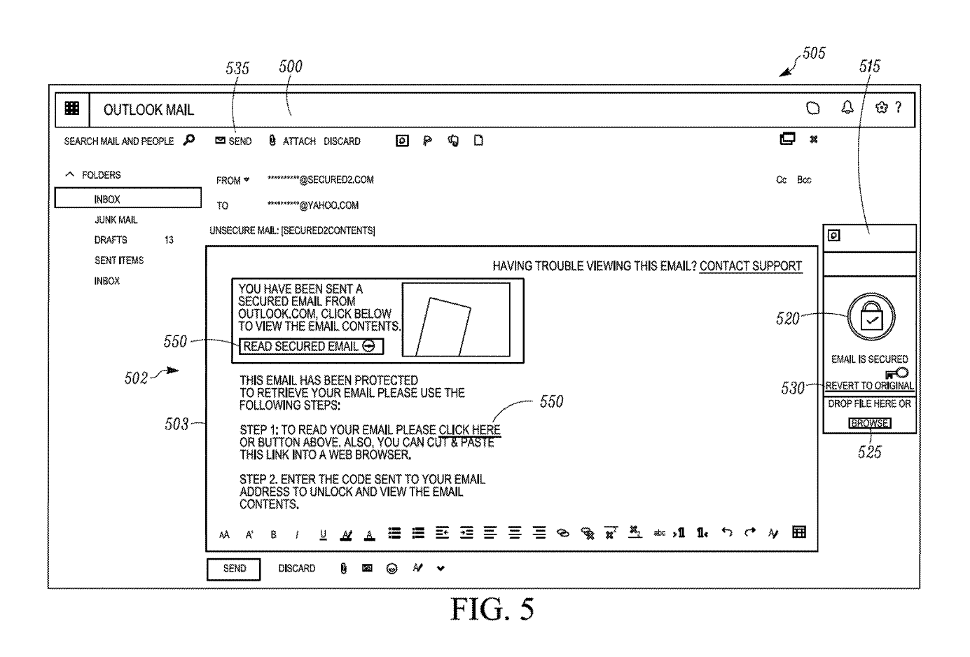

At 235, the sender email GUI and/or secured email component notifies the sender that the sender composed email has been converted to a secured email. FIG. 5 illustrates a screenshot of an email window 500 of a secured email 502, presented via a sender email GUI 505, converted from the sender composed 402 email shown in FIG. 4. The email window 500 includes a secured email body portion 503 and a secure email menu 515 that includes a secure email icon 520, an attach file option 525, and a revert option 530. In the embodiment shown in FIG. 5, the secured email body portion 503 provides notification information to the sender that that the email has been secured with instructions for retrieving the contents of the sender composed email and hyperlinks 550 that allow the sender to access the contents of the secured email 502. In some embodiments, the sender may not be able to allow the sender to provide further information to be sent to a recipient in the secured email body portion 503. The secure email icon 520 is similar to the secure email option 420 shown in FIG. 4, but indicates that the email has been secured. In FIG. 5, the secure email icon 520 depicts a lock with a check mark surrounded by a circle, whereas the secure email option 520 shown in FIG. 5 depicts a lock with an “X”. The attach file option 525, which is similar to the attach file option 425 shown in FIG. 4, allows a sender to include and secure any attachments to the email. In the embodiment shown in FIG. 5, the sender can select the attach file option 525 in order to browse and select the file(s) to be attached to the email, and/or the sender can drag and drop the file(s) to be attached at the location of the attach file option 525. The revert option 530, when selected, allows a sender to revert the secured email 502 into the sender composed email 402 as shown in FIG. 4. The method 200 then proceeds to 240.

At 240, the sender email GUI waits to receive a sender instruction to send the secured email (including any attachments stored therein). In the embodiment shown in FIG. 5, this can include the sender email GUI waiting for the sender, in the email window 500 of the email, to select a send email option 535 from the ribbon portion 505. Once the sender email GUI receives the sender instruction to send the secured email (including any attachments stored therein), the method 200 proceeds to 245.

At 245, the sender email GUI sends the secured email to each of the one or more recipients selected by the sender in the sender composed email.

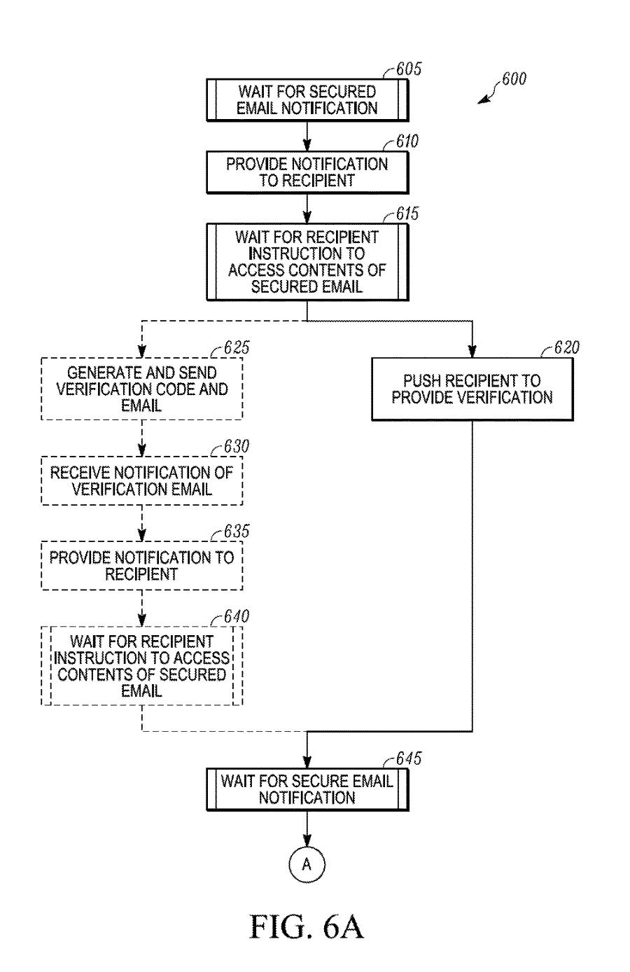

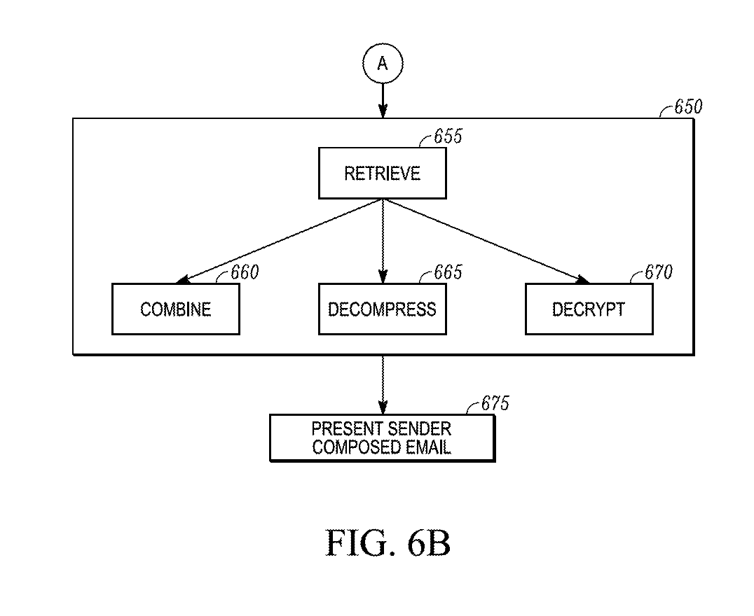

Further details of methods for accessing the sender composed email via the secured email are described below with respect to FIGS. 6-11.

FIGS. 6A and 6B are flow charts of a method 600 for accessing a sender composed email via a secured email, according to one embodiment. The method 600 begins at 605 when a recipient email GUI receives notification that a secured email has been sent to a specified recipient. The method 600 then proceeds to 610.

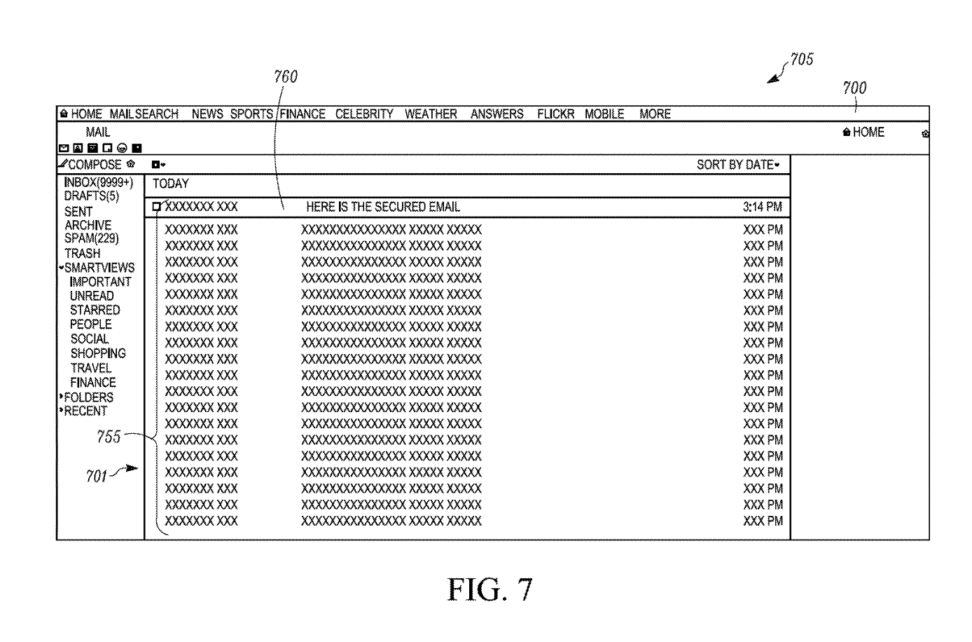

At 610, the recipient email GUI provides notification to the recipient that the recipient has received a secured email. The type of notification provided can be based on the recipient device and email configuration settings set by the recipient. FIG. 7 illustrates a screenshot 700 of an email list or bin 701, presented via a recipient email GUI 705, that includes a plurality of received email messages links 755 including an email message link 760 for a secured email. The email message link 760 indicates one or more of a sender of the secured email, a subject heading of the secured email, etc. The method 600 then proceeds to 615.

At 615, a secured email component waits for a recipient instruction to access the information provided in the secured email. In some embodiments, when the recipient selects and/or attempts to open the secured email (e.g., by selecting the email message link 760 shown in FIG. 7), the recipient email GUI can present an email window with information and instructions for accessing the contents of the secured email. In some embodiments, the email window can include one or more hyperlinks indicating that secure information is provided in the email and that the recipient can access the secure information by selecting the hyperlink(s).

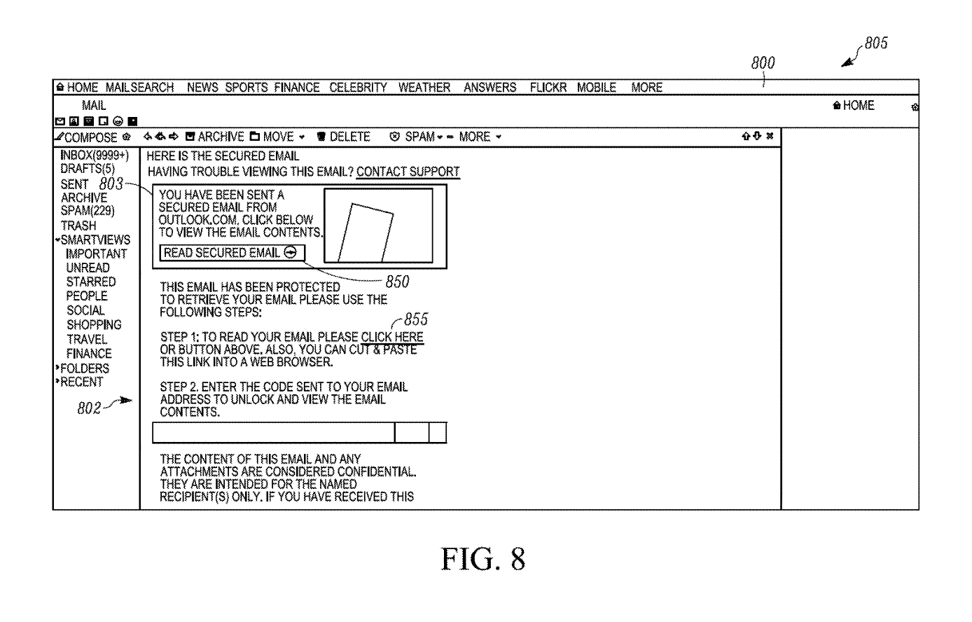

FIG. 8 illustrates a screenshot of an email window 800 of a secured email 802 presented via a recipient email GUI. The email window 800 includes a secured email body portion 803. The secured email body portion 803 provides notification information to the recipient that the email has been secured with instructions for retrieving the contents of the email and a hyperlink 850 that allows the recipient to access the contents of the secured email. As shown in FIG. 8, in some embodiments, the secured email body portion 801 further includes a second hyperlink 855 that allows the recipient to access the contents of the secured email 803.

Once the secured email component receives the recipient instruction to access the information provided in the secured email (e.g., via recipient selection of the hyperlink), the method 600 proceeds to 620. Optionally, in some embodiments, the method 600 can also proceed to optional 625. Also, in some of these embodiments, the method 600 can proceed concurrently to 620 and optional 625.

At 620, the recipient email GUI directs (e.g., pushes) the recipient to provide proper verification to access the sender composed email. The method 600 then proceeds to 645.

The recipient email GUI can direct the recipient to provide proper verification to access the sender composed email in multiple different ways. For example, in some embodiments, the recipient email GUI can direct the recipient to provide multi-factor authentication (MFA) to provide proper verification. In other embodiments, the recipient email GUI can direct the recipient to provide proper verification using facial recognition techniques. In other embodiments, the recipient email GUI can send a text message (e.g., using a short message service (SMS)) that requires, for example, a reply text from the recipient to provide proper verification. In other embodiments, the recipient email GUI can use third party authentication (e.g., sending a verification code to a third part app or device) that the recipient can use (e.g., pressing an unlock button on a smart phone) to provide proper verification. In other embodiments, the recipient email GUI can provide a verification code and/or secret that the recipient can use to provide proper verification. In some other embodiments, the recipient email GUI can provide real-time authentication (e.g., capturing a unique way the recipient types on a keyboard) to provide proper verification. In yet some other embodiments, the recipient email GUI can send a message (e.g., using email, a SMS, etc.) that includes a verification code which the recipient can provide to show proper verification.

An example of using a message that includes a verification code that the recipient can use to provide verification is discussed below with respect to optional 625, 630, 635 and 640. In one example of these embodiments, at 620, the recipient GUI can push the recipient to a secured email access GUI associated with the secured email component in order to direct the recipient to provide proper verification to access the sender composed email. The secured email access GUI can be, for example, a website on the Internet that allows a recipient to enter a verification code, such as the verification code received at optional 630 discussed below, in order to access the contents of the secured email.

At optional 625, the secured email component generates a verification code (e.g., unique key) for accessing the information provided in the secured email, generates a verification email to the recipient that includes the verification code, and sends the verification email to the recipient. The method 600 then proceeds to optional 630.

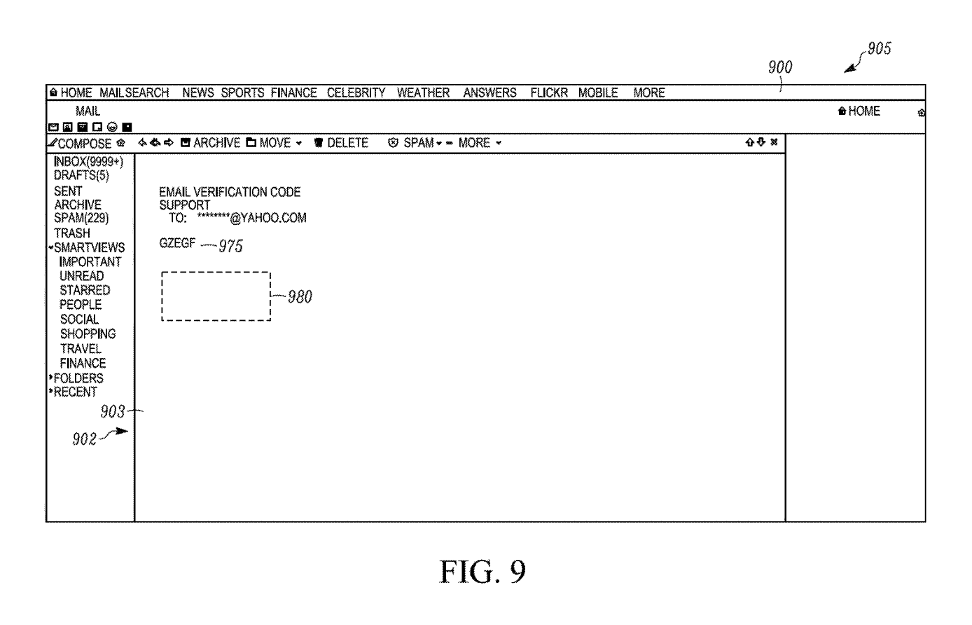

FIG. 9 illustrates a screenshot of an email window 900 of a verification email 902 generated by the secured email component at optional 625, according to one embodiment. The email window 900 includes a verification email body portion 903. The verification email body portion 903 provides a verification code 975 to the recipient that can be used for retrieving the contents of the secured email. In some embodiments, the email body portion 903 can also include a hyperlink 980 that directs the recipient to a secured email access location.

At optional 630 the recipient email GUI receives notification that a verification email has been sent to the recipient. The method 600 then proceeds to optional 635.

At optional 635, the recipient email GUI provides notification to the recipient that the recipient has received a verification email. The type of notification provided can be based on the recipient device and email configuration settings set by the recipient. The notification provided by the recipient email GUI can be a received message link such as the received message links 755 shown in FIG. 7. The method 600 then proceeds to optional 640.

At optional 640, the email server waits for a recipient instruction to access the information provided in the verification email. In some embodiments, when the recipient selects and/or attempts to open the secured email (e.g., by selecting an email message link such as the email message links 755 shown in FIG. 7), the recipient email GUI can provide an email window with a verification code for accessing the contents of the secured email. The method 630 then proceeds to 645.

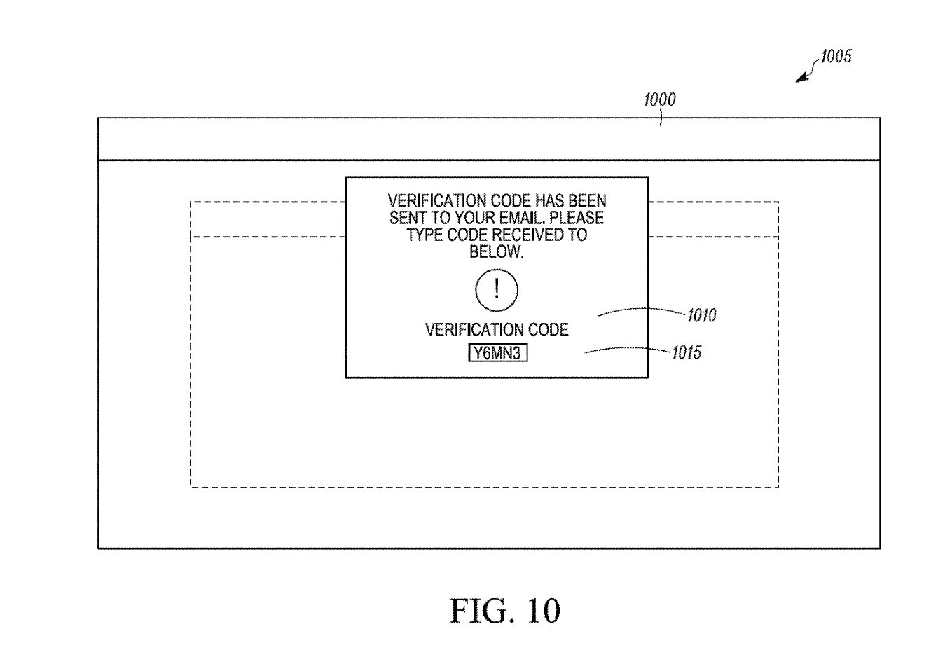

FIG. 10 illustrates a screenshot of a secured email access window 1000 presented via a secured email GUI 1005. The secured email access window 1000 includes a verification code box 1010. The verification code box 1010 includes a recipient input box 1015 that allows a recipient to enter a verification code. The verification code box 1010 can also include information notifying the recipient that a verification email has been sent to the recipient containing a verification code for accessing the contents of the secured email.

At 645, the secured email access GUI waits to receive a proper verification code. That is, the secured email access GUI can wait for a recipient to enter the verification code obtained at 630. For example, in one embodiment, the secured email access GUI can wait for the recipient to enter the verification code 975 shown in FIG. 9 into the verification code box 1010. Once a proper verification code is received by (e.g., inputted into) the secured email access GU the method 600 proceeds to 650 shown in FIG. 6B.

In some embodiments, the secured email GUI can require that the proper verification code be received within a certain time limit from when the secured email component sends the verification email to the recipient. In some embodiments, the time limit can be, for example, about 5 minutes. It is appreciated that the time limit can be greater than or less than 5 minutes as required to, for example, maintain security of the sender composed email.

As illustrated in FIG. 6B, at 650, the secured email component and/or the recipient email GUI retrieves the sender composed email (including any attachments provided therein). Retrieving the sender composed email includes: retrieving a plurality of data segments, that make up one or more files that form the sender composed email, from two or more data storage locations at 655; combining the plurality of data segments at 660; decompressing the plurality of data segments at 665; and decrypting the plurality of data segments at 670.

In some embodiments, the secured email component and/or the recipient email GUI can retrieve a report from, for example, one of the two or more data storage locations that indicates information suitable for retrieval and reassembly of the plurality of data segments that can be stored at random within the two or more data storage locations. The report can be similar to the report generated at 230 in FIG. 2.

Once the plurality of data segments are retrieved from the two or more data storage locations, the plurality of data segments can be combined (660), decompressed (665), and decrypted (670) (in no particular order).

Combining the plurality of data segments at 660 includes the combining the plurality of data segments to form one or more files that make up the sender composed email. In some embodiments, the plurality of data segments can be combined based on a report.

Decompressing the plurality of data segments at 665 includes decompressing plurality of data segments and/or the one or more files that make up the sender composed email. The plurality of data segments and/or the one or more files that make up the sender composed email can be decompressed using, for example, any suitable decompression technique and/or industry standard decompression process. In embodiments where both the plurality of data segments and the one or more files that make up the sender composed email require decompression, the decompression process used for both can be the same or different.

Decrypting the plurality of data segments at 670 includes decrypting the plurality of data segments and/or the one or more files that make up the sender composed email. The plurality of data segments and/or the one or more files that make up the sender composed email can be decrypted using, for example, any suitable decryption technique and/or industry standard decryption process. In embodiments where both the plurality of data segments and the one or more files that make up the sender composed email require decryption, the decryption process used for both can be the same or different.

Once the secured email component and/or the recipient email GUI retrieves the sender composed email (including any attachments provided therein), the method 600 proceeds to 675.

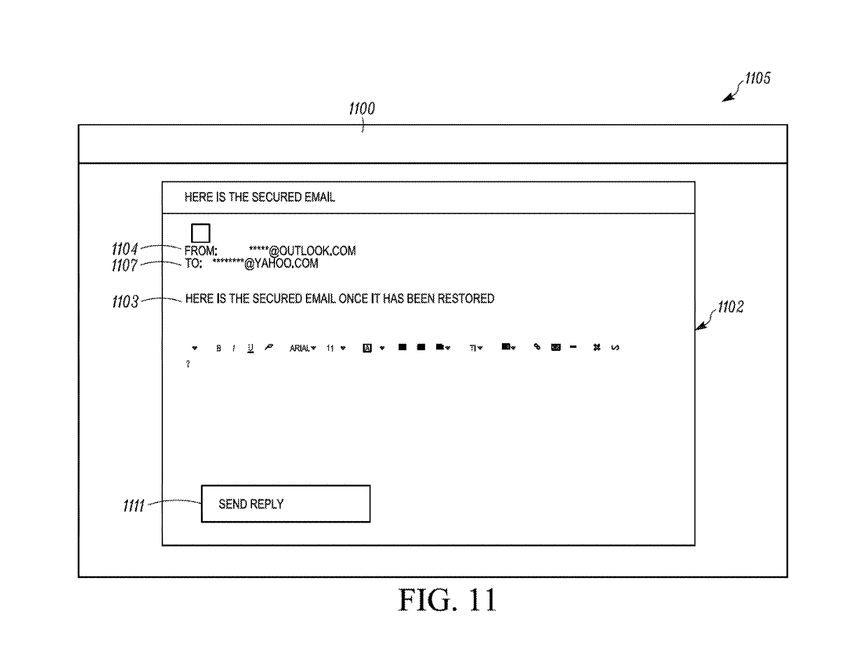

At 675, the sender composed email is presented to the recipient. In some embodiments, the secured email component can present the sender composed email to the recipient via the secured email GUI. FIG. 11 illustrates one example of an email window 1100 of a sender composed email 1102 presented via a secured email GUI 1105. The sender composed email 1102 includes an email body portion 1103, a sender portion 1104, a recipient portion 1107, and a subject portion 1109, and a reply option 1111. The email body portion 1103 includes information provided by the sender for the recipient. The sender portion 1104 identifies a particular email account(s) that sent the sender composed email 1102. The recipient portion 1107 identifies the intended recipient(s) of the sender composed email 1102. The subject portion 1109 identifies a subject line for the sender composed email 1102. The reply option 1111 allows the recipient to send a reply email to the sender. In other embodiments, the recipient email GUI can present the sender composed email. For example, the recipient email GUI can replace the secured email presented by the recipient email GUI at 615 (e.g., as shown in FIG. 8).

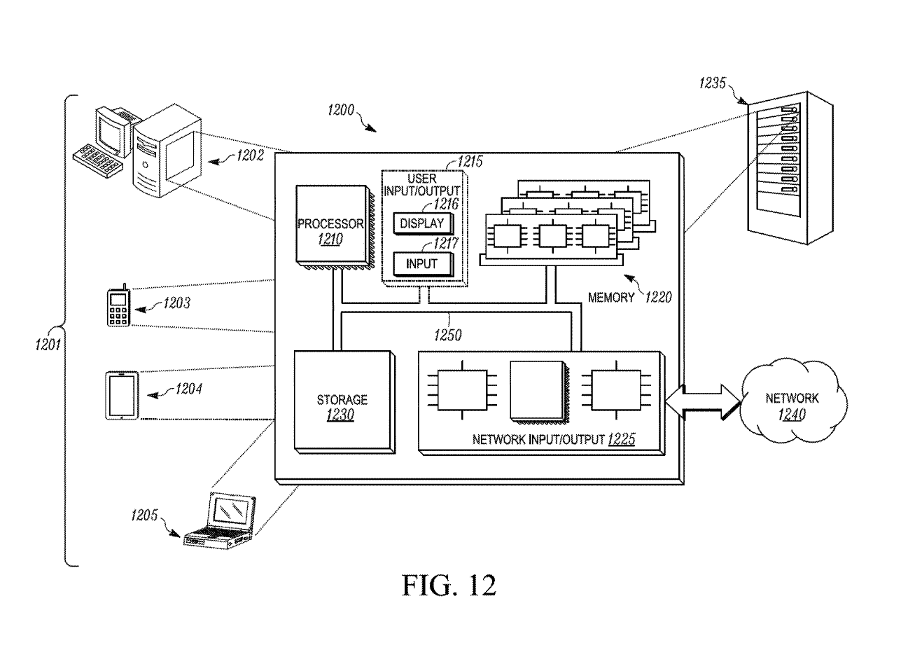

FIG. 12 is a schematic diagram of an exemplary architecture for a computer device 100, such as the one or more computer devices described above with respect to FIGS. 1-11. The computer device 1200 and 1220 any of the individual components thereof can be used for any of the operations described in accordance with any of the computer-implemented systems and methods described herein.

The computer device 1200 generally includes a processor 1210, memory 1220, a network input/output (I/O) 1225, storage 1230, and an interconnect 1250. The computer device 1200 can optionally include a user I/O 1215, according to some embodiments. The computer device 1200 can be in communication with one or more additional computer devices 1200 through a network 1240.

The computer device 1200 is generally representative of hardware aspects of a variety of user devices 1201 and a server device 1235. The illustrated user devices 1201 are exemplary and are not intended to be limiting. Examples of the user devices 1201 include, but are not limited to, a desktop computer 1202, a cellular/mobile phone 1203, a tablet device 1204, and a laptop computer 1205. It is to be appreciated that the user devices 1201 can include other devices such as, but not limited to, a personal digital assistant (PDA), a video game console, a television, or the like. In some embodiments, the user devices 1201 can alternatively be referred to as client modules 1201. In such embodiments, the client modules 1201 can be in communication with the server device 1235 through the network 1240. One or more of the client modules 1201 can be in communication with another of the client modules 1201 through the network 1240 in some embodiments.

The processor 1210 can retrieve and execute programming instructions stored in the memory 1220 and/or the storage 1230. The processor 1210 can also store and retrieve application data residing in the memory 1220. The interconnect 1250 is used to transmit programming instructions and/or application data between the processor 510, the user I/O 1215, the memory 1220, the storage 1230, and the network I/O 1240. The interconnect 1250 can, for example, be one or more busses or the like. The processor 1210 can be a single processor, multiple processors, or a single processor having multiple processing cores. In some embodiments, the processor 1210 can be a single-threaded processor. In some embodiments, the processor 1210 can be a multi-threaded processor.

The user I/O 1215 can include a display 1216 and/or an input 1217, according to some embodiments. It is to be appreciated that the user I/O 1215 can be one or more devices connected in communication with the computer device 500 that is physically separate from the computer device 1200. For example, the display 1216 and input 1217 for the desktop computer 1202 can be connected in communication but be physically separate from the computer device 1200. In some embodiments, the display 1216 and input 1217 can be physically included with the computer device 1200 for the desktop computer 1202. In some embodiments, the user I/O 1215 can physically be part of the user device 1201. For example, the cellular/mobile phone 1203, the tablet device 1204, and the laptop 1205 include the display 1216 and input 1217 that are part of the computer device 1200. The server device 1235 generally may not include the user I/O 1215. In some embodiments, the server device 1235 can be connected to the display 1216 and input 1217.

The display 1216 can include any of a variety of display devices suitable for displaying information to the user. Examples of devices suitable for the display 1216 include, but are not limited to, a cathode ray tube (CRT) monitor, a liquid crystal display (LCD) monitor, a light emitting diode (LED) monitor, or the like.

The input 1217 can include any of a variety of input devices or means suitable for receiving an input from the user. Examples of devices suitable for the input 1217 include, but are not limited to, a keyboard, a mouse, a trackball, a button, a voice command, a proximity sensor, an ocular sensing device for determining an input based on eye movements (e.g., scrolling based on an eye movement), or the like. It is to be appreciated that combinations of the foregoing inputs 1217 can be included for the user devices 1201. In some embodiments the input 1217 can be integrated with the display 1216 such that both input and output are performed by the display 1216.

The memory 1220 is generally included to be representative of a random access memory such as, but not limited to, Static Random Access Memory (SLAM), Dynamic Random Access Memory (DRAM), or Flash. In some embodiments, the memory 1220 can be a volatile memory. In some embodiments, the memory 1220 can be a non-volatile memory. In some embodiments, at least a portion of the memory can be virtual memory.

The storage 1230 is generally included to be representative of a non-volatile memory such as, but not limited to, a hard disk drive, a solid state device, removable memory cards, optical storage, flash memory devices, network attached storage (NAS), or connections to storage area network (SAN) devices, or other similar devices that may store non-volatile data. In some embodiments, the storage 1230 is a computer readable medium. In some embodiments, the storage 1230 can include storage that is external to the computer device 1200, such as in a cloud.

The network I/O 525 is configured to transmit data via a network 1240. The network 1240 may alternatively be referred to as the communications network 1240. Examples of the network 1240 include, but are not limited to, a local area network (LAN), a wide area network (WAN), the Internet, or the like. In some embodiments, the network I/O 525 can transmit data via the network 1240 through a wireless connection using WiFi, Bluetooth, or other similar wireless communication protocols. In some embodiments, the computer device 1200 can transmit data via the network 1240 through a cellular, 3G, 4G, or other wireless protocol. In some embodiments, the network I/O 1225 can transmit data via a wire line, an optical fiber cable, or the like. It is to be appreciated that the network I/O 1225 can communicate through the network 1240 through suitable combinations of the preceding wired and wireless communication methods.

The server device 1235 is generally representative of a computer device 1200 that can, for example, respond to requests received via the network 1240 to provide, for example, data for rendering a website on the user devices 1201. The server device 1235 can be representative of a data server, an application server, an Internet server, or the like.

Aspects described herein can be embodied as a system, method, or computer readable medium. In some embodiments, the aspects described can be implemented in hardware, software (including firmware or the like), or combinations thereof. Some aspects can be implemented in a computer readable medium, including computer readable instructions for execution by a processor. Any combination of one or more computer readable medium(s) can be used.

The computer readable medium can include a computer readable signal medium and/or a computer readable storage medium. A computer readable storage medium can include any tangible medium capable of storing a computer program for use by a programmable processor to perform functions described herein by operating on input data and generating an output. A computer program is a set of instructions that can be used, directly or indirectly, in a computer system to perform a certain function or determine a certain result. Examples of computer readable storage media include, but are not limited to, a floppy disk, a hard disk; a random access memory (RAM); a read-only memory (ROM); a semiconductor memory device such as, but not limited to, an erasable programmable read-only memory (EPROM), an electrically erasable programmable read-only memory (EEPROM), Flash memory, or the like; a portable compact disk read-only memory (CD-ROM); an optical storage device; a magnetic storage device; other similar device; or suitable combinations of the foregoing. A computer readable signal medium can include a propagated data signal having computer readable instructions. Examples of propagated signals include, but are not limited to, an optical propagated signal, an electro-magnetic propagated signal, or the like. A computer readable signal medium can include any computer readable medium that is not a computer readable storage medium that can propagate a computer program for use by a programmable processor to perform functions described herein by operating on input data and generating an output.

Some embodiments can be provided to an end-user through a cloud-computing infrastructure. Cloud computing generally includes the provision of scalable computing resources as a service over a network (e.g., the Internet or the like).

Although a number of methods and systems are described herein, it is contemplated that a single system or method can include more than one of the above discussed subject matter. Accordingly, multiple of the above systems and methods can be used together in a single system or method.

### Abstract

It will be appreciated that any of the features in aspects 1-9, 10-17 and 18-29 can be combined.

Aspect 1. A method for generating and sending a secure email to a recipient, the method comprising:

receiving, via a sender email graphical user interface (GUI), a secure email instruction to secure the sender composed email;

converting the sender composed email into a secured email; and

the sender email GUI sending the secured email to a recipient.

Aspect 2. The method of aspect 1, wherein converting the sender composed email into the secured email includes:

shredding the sender composed email into a plurality of data segments:

assigning each of the plurality of data segments to one of a plurality of data storage locations;

dispersing the plurality of data segments to the plurality of data storage locations.

Aspect 3. The method of aspect 2, wherein converting the sender composed email into the secured email includes generating a report with information for retrieving all of the plurality of data segments stored in the plurality of data storage locations.

Aspect 4. The method of either one of aspects 2 or 3, wherein assigning each of the plurality of data segments to one of the plurality of data storage locations includes, for each of the plurality of data segments, randomly assigning a data storage location from a sender generated list of the plurality of data storage locations.

Aspect 5. The method of any one of aspects 1-4, wherein converting the sender composed email into the secured email is performed by a secured email component.

Aspect 6. The method of any one of aspects 1-5, wherein the sender composed email includes an attachment file.

Aspect 7. The method of any one of aspects 1-6, further comprising:

waiting for a secure email instruction to secure the sender composed email prior to converting the sender composed email into the secured email.

Aspect 8. The method of any one of aspects 1-7, further comprising:

notifying a sender that the sender composed email is secured after converting the sender composed email into the secured email.

Aspect 9. The method of any one of aspects 1-8, wherein the sender composed email includes an attachment file enclosed therein, and

wherein converting the sender composed email into a secured email includes converting the attachment.

Aspect 10. A method for accessing a sender composed email via a secured email, the method comprising:

a recipient email graphical user interface (GUI) receiving notification of a secured email;

receiving a recipient instruction to access contents of the sender composed email;

directing the recipient to provide verification for access to the sender composed email:

verifying that the recipient has access to the sender composed email; and

retrieving the sender composed email upon receiving verification from the verification page.

Aspect 11. The method of aspect 10, wherein directing the recipient to provide verification for access to the sender composed email includes:

a secured email component generating a verification code and sending the verification code to the recipient; and

presenting a verification page to the recipient.

Aspect 12. The method of aspect 11, wherein the secured email component sending the verification code to the recipient includes the secured email component generating a verification email including the verification code and the secured email component sending the verification email to the recipient email GUI.

Aspect 13. The method of either one of aspects 11 or 12, wherein verifying that the recipient has access to the sender composed email includes the secured email component receiving an input of the verification code at the verification page.

Aspect 14. The method of any one of aspects 10-13, wherein retrieving the sender composed email includes:

retrieving a plurality of data segments that form the sender composed email and that are stored in a plurality of data storage locations; and

combining the plurality of data segments into the sender composed email.

Aspect 15. The method of any one of aspects 10-14, wherein retrieving the sender composed email includes retrieving a report with information for retrieving all of the plurality of data segments stored in the plurality of data storage locations.

Aspect 16. The method of any one of aspects 10-15, further comprising presenting the sender composed email to the recipient upon retrieving the sender composed email.

Aspect 17. The method of any one of aspects 10-16, wherein the sender composed email includes an attachment file enclosed therein.

Aspect 18. A secure email transmission system comprising:

a sender email graphical user interface (GUI) that generates a sender composed email and sends a secured email to a recipient email GUI; and

a recipient email GUI that retrieves the secured email and presents the sender composed email to a recipient.

Aspect 19. The secure email transmission system of aspect 18, wherein the secure email transmission system shreds the sender composed email into a plurality of data segments, assigns each of the plurality of data segments to one of a plurality of data storage locations, and disperses the plurality of data segments to the plurality of data storage locations.

Aspect 20. The secure email transmission system of aspect 19, wherein the secure email transmission system, for each of the plurality of data segments, randomly assigns a data storage location from a sender generated list of the plurality of data storage locations.

Aspect 21. The secure email transmission of either one of aspects 19 or 20, wherein the secure email transmission system generates a report with information for retrieving all of the plurality of data segments stored in the plurality of data storage locations.

Aspect 22. The secure email transmission system of any one of aspects 19-21, wherein the sender email GUI shreds the sender composed email into a plurality of data segments, assigns each of the plurality of data segments to one of a plurality of data storage locations, and disperses the plurality of data segments to the plurality of data storage locations.

Aspect 23. The secure email transmission system of any one of aspects 18-22, further comprising a secured email component that shreds the sender composed email into a plurality of data segments, assigns each of the plurality of data segments to one of a plurality of data storage locations, and disperses the plurality of data segments to the plurality of data storage locations.

Aspect 24. The secure email transmission system of aspect 23, wherein the secured email component is part of the sender email GUI.

Aspect 25. The secure email transmission system of any one of aspects 18-24, wherein the secure email transmission system retrieves a plurality of data segments that form the sender composed email and that are stored in a plurality of data storage locations, and

wherein the secure email transmission system combines the plurality of data segments into the sender composed email.

Aspect 26. The secure email transmission system of aspect 25, wherein the secure email transmission system retrieves a report with information for retrieving all of the plurality of data segments stored in the plurality of data storage locations.

Aspect 27. The secure email transmission system of either one of aspects 25 or 26, wherein the secured email component verifies that the recipient has access to the sender composed email.

Aspect 28. The secure email transmission of any one of aspects 18-28, further comprising a secured email component that generates a verification code and sends the verification code to the recipient upon the recipient email GUI receiving a recipient instruction to access contents of the sender composed email.

Aspect 29. The secure email transmission system of any one of aspects 18-28, wherein the sender composed email includes an attachment file enclosed therein.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

What is claimed is:

1. A method for generating and sending a secure email to a recipient, the method comprising:
receiving, via a sender email graphical user interface (GUI), a secure email instruction to secure the sender composed email;
converting the sender composed email into a secured email; and
the sender email GUI sending the secured email to a recipient.

2. The method of claim 1, wherein converting the sender composed email into the secured email includes:
shredding the sender composed email into a plurality of data segments;
assigning each of the plurality of data segments to one of a plurality of data storage locations;
dispersing the plurality of data segments to the plurality of data storage locations.

3. The method of claim 2, wherein assigning each of the plurality of data segments to one of the plurality of data storage locations includes, for each of the plurality of data segments, randomly assigning a data storage location from a sender generated list of the plurality of data storage locations.

4. The method of claim 1, further comprising:
waiting for a secure email instruction to secure the sender composed email prior to converting the sender composed email into the secured email.

5. The method of claim 1, further comprising:
notifying a sender that the sender composed email is secured after converting the sender composed email into the secured email.

6. The method of claim 1, wherein the sender composed email includes an attachment file enclosed therein, and
wherein converting the sender composed email into a secured email includes converting the attachment.

7. A method for accessing a sender composed email via a secured email, the method comprising:
a recipient email graphical user interface (GUI) receiving notification of a secured email;
receiving a recipient instruction to access contents of the sender composed email;
directing the recipient to provide verification for access to the sender composed email;
verifying that the recipient has access to the sender composed email; and
retrieving the sender composed email upon receiving verification from the verification page.

8. The method of claim 7, wherein directing the recipient to provide verification for access to the sender composed email includes:
a secured email component generating a verification code and sending the verification code to the recipient; and
presenting a verification page to the recipient.

9. The method of claim 8, wherein the secured email component sending the verification code to the recipient includes the secured email component generating a verification email including the verification code and the secured email component sending the verification email to the recipient email GUI.

10. The method of claim 8, wherein verifying that the recipient has access to the sender composed email includes the secured email component receiving an input of the verification code at the verification page.

11. The method of claim 7, wherein retrieving the sender composed email includes:
retrieving a plurality of data segments that form the sender composed email and that are stored in a plurality of data storage locations; and
combining the plurality of data segments into the sender composed email.

12. The method of claim 10, further comprising presenting the sender composed email to the recipient upon retrieving the sender composed email.

13. A secure email transmission system comprising:
a sender email graphical user interface (GUI) that generates a sender composed email and sends a secured email to a recipient email GUI; and
a recipient email GUI that retrieves the secured email and presents the sender composed email to a recipient.

14. The secure email transmission system of claim 13, wherein the secure email transmission system shreds the sender composed email into a plurality of data segments, assigns each of the plurality of data segments to one of a plurality of data storage locations, and disperses the plurality of data segments to the plurality of data storage locations.

15. The secure email transmission system of claim 14, wherein the secure email transmission system, for each of the plurality of data segments, randomly assigns a data storage location from a sender generated list of the plurality of data storage locations.

16. The secure email transmission system of claim 13, wherein the sender email GUI shreds the sender composed email into a plurality of data segments, assigns each of the plurality of data segments to one of a plurality of data storage locations, and disperses the plurality of data segments to the plurality of data storage locations.

17. The secure email transmission system of claim 13, further comprising a secured email component that shreds the sender composed email into a plurality of data segments, assigns each of the plurality of data segments to one of a plurality of data storage locations, and disperses the plurality of data segments to the plurality of data storage locations.

18. The secure email transmission system of claim 13, wherein the secure email transmission system retrieves a plurality of data segments that form the sender composed email and that are stored in a plurality of data storage locations, and
wherein the secure email transmission system combines the plurality of data segments into the sender composed email.

19. The secure email transmission system of claim 17, wherein the secured email component is part of the sender email GUI.

20. The secure email transmission of claim 13, further comprising a secured email component that generates a verification code and sends the verification code to the recipient upon the recipient email GUI receiving a recipient instruction to access contents of the sender composed email.
